(19) United States
(12) Patent Application Publication
(10) Pub. No.: US 2017/0070835 A1
(43) Pub. Date: Mar. 9, 2017

(54) SYSTEM FOR GENERATING IMMERSIVE AUDIO UTILIZING VISUAL CUES

(71) Applicant: Intel Corporation, Santa Clara, CA (US)

(72) Inventor: ANDRADIGE PUBUDU MADHAWA SILVA, Hillsboro, OR (US)

(73) Assignee: Intel Corporation, Santa Clara, CA (US)

(21) Appl. No.: 14/847,346

(22) Filed: Sep. 8, 2015

(51) Int. Cl. H04S 1/00; H04N 5/92; G11B 27/034

(52) U.S. Cl. CPC H04S 1/002; G11B 27/034; H04N 5/92

(57) ABSTRACT

The present disclosure is directed to a system for generating immersive audio utilizing visual cues. In general, a system may be capable of transforming non-spatial audio (e.g., simple mono or stereo sound) associated with video into immersive sound (e.g., wherein sound may be generated spatially so that it appears to emanate directly from sound sources in the video). An example device may comprise data sourcing circuitry to receive multimedia data including at least video and non-spatial audio corresponding to the video, data analysis circuitry to determine at least one source of audio in the video and at least one attributable sound in the audio and audio generation circuitry to generate immersive audio wherein the at least one attributable sound is at least spatially associated with the at least one source of audio. Audio sources in the video may be determined using a variety of different types of detection.

### TECHNICAL FIELD

The present disclosure relates to multimedia systems, and more particularly, to a system for generating immersive audio by spatially associating sounds with determined sound sources.

### BACKGROUND

Multimedia data may, in general, comprise various combinations of textual data, image data, audio data, video data, data for creating tactile feedback, etc. In many instances video data may be combined with audio data to create a multimedia presentation. Presentation may include, for example, displaying a video based on the video data and generating sound based on the audio data. Multimedia data may be stored within a device for later presentation at a user's discretion, downloaded fully from a remote resource over a network (e.g., the Internet) prior to presentation, downloaded and presented at the substantially the same time (e.g., “streamed”) or even captured by equipment in, or at least coupled to, the device for storage in the device (e.g., recorded video) or immediate presentation (e.g., video conferencing). In this manner, a device may be capable of presenting a variety of different multimedia data to a user at virtually any time, in any place, etc.

Further to the above, new technologies may enhance the experience of the user during the presentation of multimedia data. For example, the video data may be presented at very high resolution, in a format that may simulate three-dimensions (3D), etc. In a similar manner, audio may be presented in a manner that creates the illusion that sound is coming from different sound sources in a video. This format of enhanced audio presentation may be deemed “immersive” in that the spatial nature of the sound (e.g., the apparent position of sound origin, the direction from which sound appears to originate, etc.) generated during playback of the video and audio allows users to feel “immersed in an illusion” created by the multimedia presentation. Immersive audio is available in both existing and emerging media such as, for example, television shows, movies, video games, etc. The media creators must go to great lengths to produce video with immersive audio. For example, video productions may be written, storyboarded, produced, edited, etc. with the end goal of creating a product that immerses an audience in a certain illusion. As part of the creative process, the audio portion of the multimedia production must also go through substantial postproduction processing to design immersive audio that, when paired with the video portion of a multimedia production, places the user into a situation that allows the user to imagine that they are actually experiencing the multimedia presentation instead of just watching and listening to it.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system for generating immersive audio utilizing visual cues in accordance with at least one embodiment of the present disclosure;

FIG. 2 illustrates an example configuration for at least one device and a peripheral device usable in accordance with at least one embodiment of the present disclosure;

FIG. 3 illustrates an example wherein non-spatial audio is converted to immersive audio in accordance with at least one embodiment of the present disclosure;

FIG. 4 illustrates an example wherein user head position is considered when generating immersive audio in accordance with at least one embodiment of the present disclosure; and

FIG. 5 illustrates example operations for generating immersive audio utilizing visual cues in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure is directed to a system for generating immersive audio utilizing visual cues. In general, a system may be capable of transforming non-spatial audio (e.g., simple mono or stereo sound) associated with video into immersive sound (e.g., wherein sound may be generated spatially so that it appears to emanate directly from sound sources in the video). An example device may comprise data sourcing circuitry to receive multimedia data including at least video and non-spatial audio corresponding to the video, data analysis circuitry to determine at least one source of audio in the video and at least one attributable sound in the audio and audio generation circuitry to generate immersive audio wherein the at least one attributable sound is at least spatially associated with the at least one source of audio. Audio sources in the video may be determined using a variety of different types of detection. In at least one embodiment, the generation of the immersive audio may also take into account the position of a user's head. In this manner, the generation of the immersive audio may be adjusted to maintain the at least one attributable sound associated with the at least one source of audio regardless of head movement.

In at least one embodiment, at least one device for generating immersive audio may comprise, for example, data analysis circuitry and audio generation circuitry. The data analysis circuitry may be to analyze multimedia data including video and non-spatial audio, wherein analyzing the multimedia data may include determining at least one source of audio within the video and at least one attributable sound within the non-spatial audio. The audio generation circuitry may be to generate immersive audio wherein the at least one attributable sound is at least spatially associated with the at least one source of audio.

In at least one embodiment, the at least one device may further comprise data sourcing circuitry to receive multimedia data including at least video and non-spatial audio corresponding to the video. The at least one device may also comprise presentation circuitry to present at least one of the video or the immersive audio. The at least one device may also comprise at least one of memory circuitry to store at least one of the video or the immersive audio, capture equipment to capture the video or communication circuitry to interact with a wired or wireless network to receive the video from at least one external source. The communication circuitry may also be to transmit at least one of the video, non-spatial audio or immersive audio to a peripheral device for at least one of processing or presentation. In at least one embodiment, the audio generation circuitry may be to alter a spatial orientation with which the at least one attributable sound is associated in the immersive audio based on a position or orientation of a user's head determined by the at least one device.

In determining at least one source of audio within the video, the data analysis circuitry may be to identify certain motion in the video. In identifying certain motion, the data analysis circuitry may be to detect at least one face in the video and detect speech-related motion occurring within the at least one face and/or detect motion of an object occurring in the video. Alone or in combination with the above, in determining at least one source of audio within the video the data analysis circuitry may further be to identify sources of heat in the video and/or identify certain objects in the video based on depth. Consistent with the present disclosure, an example method for generating immersive audio may comprise triggering video capture or video presentation in at least one device, the video including non-spatial audio, determining, in the at least one device, at least one source of audio within the video, determining, in the at least one device, at least one attributable sound in the non-spatial audio and generating, in the at least one device, immersive audio wherein the at least one attributable sound is at least spatially associated with the at least one source of audio.

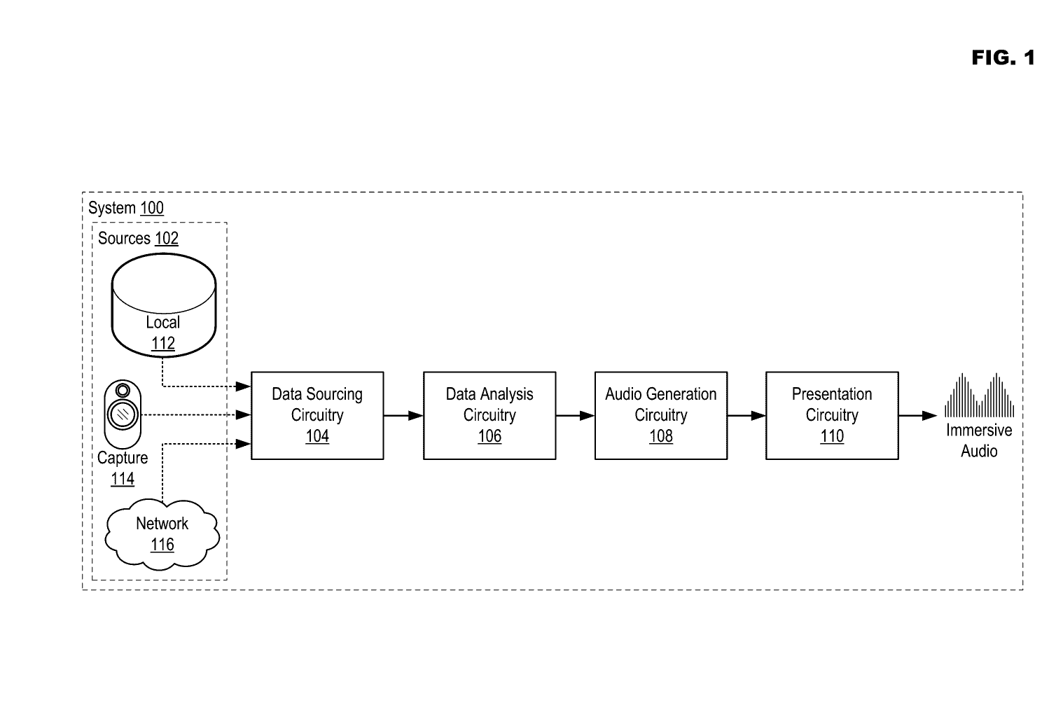

FIG. 1 illustrates an example system for generating immersive audio utilizing visual cues in accordance with at least one embodiment of the present disclosure. While this disclosure may discuss implementations that utilize particular technologies such as RealSense® technology from the Intel Corporation, these examples are offered merely readily comprehensible examples from which the various apparatuses, systems, methodologies, etc. discussed herein may be understood. Visual cues, as referenced herein, may include detectable aspects (e.g., people, objects, motion events, heat images, semantics, etc.) found within a video portion of a multimedia data including at least video and audio.

It is both expensive and complex to capture spatialized audio. Thus, most recordings or live streaming does not comprise spatial sound output. Stereo sound may be available in some instances, but stereo output only provides a panning effect and that is far inferior to spatialized sound. Moreover, it is very difficult to recreate a quality spatial audio environment in variable user (e.g., end viewer/listener) environments even when a spatial acoustic stream is captured with the video. Consistent with the present disclosure, a customized spatial audio experience may be generated for each user based only on video and non-spatial audio streams as the input.

System 100 may, in general, be configured to receive multimedia data including at least video and non-spatial audio, and to convert the non-spatial audio into immersive audio. System 100 may comprise, for example, sources 102, data sourcing circuitry 104, data analysis circuitry 106, audio generation circuitry 108 and presentation circuitry 110. Data sourcing circuitry may be able to receive multimedia data from various sources 102 including, for example, local source 112, data capture equipment 114 and network sources 116. Local source may comprise a fixed or removable storage device including, for example, an electromechanical hard drive (HD), solid state drive (SSD), etc. Capture equipment 114 may comprise at least an image/video capture device (e.g., camera) and an audio capture device (e.g., microphone). The camera may be able to sense visible light to, for example, generate human-perceivable images/video, as well as infrared and ultraviolet light for use in related applications such as depth determination, night vision, heat imaging, etc. Network source 116 may comprise at least one external resource that is accessible via a global area network (GAN), a wide area network (WAN) like the Internet, a local area network (LAN), etc. For example, network source 116 may be a cloud storage location (e.g., at least one server configured to store data accessible via the Internet), a provider of streaming multimedia data, etc.

Data sourcing circuitry 104, data analysis circuitry 106, audio generation circuitry 108 and presentation circuitry 110 may comprise hardware, combinations of hardware and software, etc. configured to generate immersive audio. “Hardware” as referenced herein, may include, for example, discrete analog and/or digital components (e.g., arranged on a printed circuit board (PCB) to form circuitry), at least one integrated circuit (IC), at least one group or set of ICs that may be configured to operate cooperatively (e.g., chipset), a group of IC functionality fabricated on one substrate (e.g., System-on-Chip (SoC)), or combinations thereof. In at least one example embodiment, a least a portion of data sourcing circuitry 104, data analysis circuitry 106, audio generation circuitry 108 and presentation circuitry 110 may be composed of software that, when loaded into the memory of a device, may cause processing circuitry in the device to transform from general purpose processing circuitry to specialized circuitry configured to perform certain functions based on code, instructions, data, etc. within the software portion of circuitry 104-110.

In an example of operation, the triggering of multimedia data capture or presentation may cause data sourcing circuitry 104 to receive multimedia data. Data capture or presentation may be triggered by, for example, user interaction directly with system 100, user interaction with at least one application on system 100, automatically within system 100, etc. Data sourcing circuitry 104 may simply receive the multimedia data, or may actively request the multimedia data be provided by interacting with at least one of sources 102. Data sourcing circuitry 104 may then provide the multimedia data to data analysis circuitry 106, which may proceed to determine at least one source of audio in a video portion of the multimedia data, and determined at least one attributable sound in non-spatial audio in the multimedia data. A source of audio may comprise an object or activity within the content of the video that would make noise such as, for example, a person, an animal, an object (e.g., vehicle or other moving object) an event (e.g., explosion, collision, etc.), etc. Attributable sound would be sounds within the audio that may be attributed to a determined source of audio. For example, some audio in a video is atmospheric (e.g., not emanating from a person, object or event presented in the video), and thus would not be attributable. Following the above determinations, audio generation circuitry 108 may proceed to generate immersive audio for presentation along with the video (e.g., by presentation circuitry 110). As referenced herein, “immersive audio” may comprise audio that, when presented, creates a spatial sound field for the user so that sounds are connected spatially with their sources in the video. For example, the voice of a person talking in a video would be presented so that it appears to come from where the person talking is presented in the video. Moreover, vehicles that drive across a display or screen during presentation of a video may have a corresponding sound that is presented with a Doppler effect, the sound off explosions may appear to the user to emanate from where they are presented on the screen, etc. These immersive audio effects may be orchestrated for the user by generating digital audio data encoded in a manner that allows modern surround sound processing systems to decode the audio effects and generate sound, in synchronization with the video, that users may perceive to come from certain a direction, even if there is no actual audio reproduction equipment (e.g., speaker) in the particular direction from which the sound appears to emanate. In this manner, a user may be fully “immersed” in a multimedia presentation, even if the original audio corresponding to the video was non-spatial.

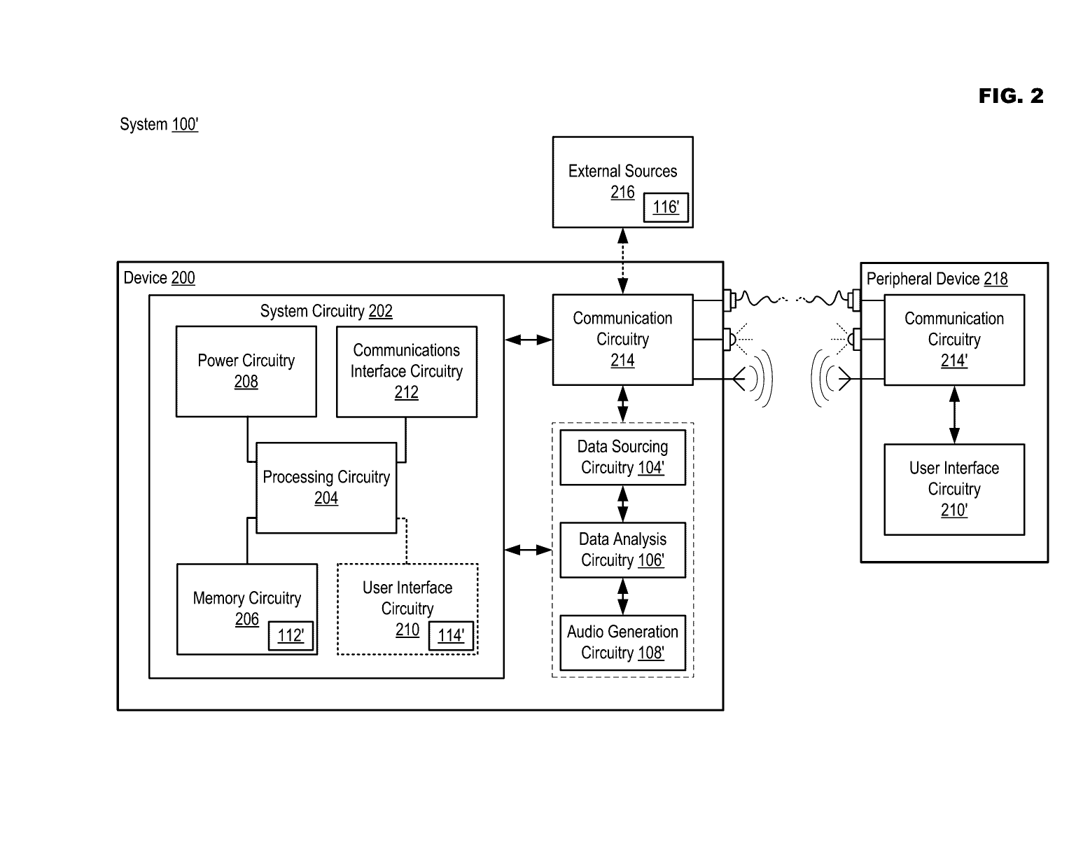

FIG. 2 illustrates an example configuration for at least one device and a peripheral device usable in accordance with at least one embodiment of the present disclosure. Consistent with the present disclosure, data sourcing circuitry 104, data analysis circuitry 106, audio generation circuitry 108 and presentation circuitry 110 may be implemented within one device (e.g., device 200), in a combination of similarly-configured devices (e.g., a group of networked rack or edge servers) or in a combination of differently-configured devices (e.g., a wearable interface device and a data processing device). Examples of devices usable in possible implementations may include, but are not limited to, a mobile communication device such as a cellular handset or a smartphone based on the Android® OS from the Google Corporation, iOS® or Mac OS® from the Apple Corporation, Windows® OS from the Microsoft Corporation, Linux® OS, Tizen® OS and/or other similar operating systems that may be deemed derivatives of Linux® OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle® from the Amazon Corporation, etc., an Ultrabook® including a low-power chipset from the Intel Corporation, a netbook, a notebook, a laptop, a palmtop, etc., a wearable device such as a wristwatch form factor computing device like the Galaxy Gear® from Samsung, Apple Watch® from the Apple Corporation, etc., an eyewear form factor computing device/user interface like Google Glass® from the Google Corporation, a virtual reality (VR) headset device like the Gear VR® from the Samsung Corporation, the Oculus Rift® from the Oculus VR Corporation, etc., a typically stationary computing device such as a desktop computer, a server, a group of computing devices organized in a high performance computing (HPC) architecture, a smart television or other type of “smart” device, small form factor computing solutions (e.g., for space-limited applications, TV set-top boxes, etc.) like the Next Unit of Computing (NUC) platform from the Intel Corporation, etc.

The inclusion of an apostrophe after an item number (e.g., 104′) in the present disclosure indicates that an example embodiment of the particular item is being illustrated. Example device 200 and peripheral device 218 may be capable of supporting any or all of the activities illustrated in FIG. 1. However, devices 200 and 218 are presented only as examples of apparatuses usable in various embodiments consistent with the present disclosure, and are not intended to limit any of the various embodiments to any particular manner of configuration, implementation, etc.

Device 200 may comprise, for example, system circuitry 202 to manage device operation. System circuitry 202 may include, for example, processing circuitry 204, memory circuitry 206, power circuitry 208, user interface circuitry 210 and communications interface circuitry 212. Device 200 may further include communication circuitry 214, data sourcing circuitry 104′, data analysis circuitry 106′ and audio generation circuitry 108′. While communication circuitry 214, data sourcing circuitry 104′, data analysis circuitry 106′ and audio generation circuitry 108′ are shown as separate from system circuitry 202, the example configuration of device 200 has been provided herein merely for the sake of explanation. Some or all of the functionality associated with communication circuitry 214, data sourcing circuitry 104′, data analysis circuitry 106′ and audio generation circuitry 108′ may also be incorporated into system circuitry 202.

In device 200, processing circuitry 204 may comprise one or more processors situated in separate components, or alternatively one or more processing cores situated in one component (e.g., in an SoC), along with processor-related support circuitry (e.g., bridging interfaces, etc.). Example processors may include, but are not limited to, various x86-based microprocessors available from the Intel Corporation including those in the Pentium, Xeon, Itanium, Celeron, Atom, Quark, Core i-series, Core M-series product families, Advanced RISC (e.g., Reduced Instruction Set Computing) Machine or “ARM” processors or any other evolution of computing paradigm or physical implementation of such integrated circuits (ICs), etc. Examples of support circuitry may include chipsets (e.g., Northbridge, Southbridge, etc. available from the Intel Corporation) configured to provide an interface via which processing circuitry 204 may interact with other system components that may be operating at different speeds, on different buses, etc. in device 200. Moreover, some or all of the functionality commonly associated with the support circuitry may also be included in the same physical package as the processor (e.g., such as in the Sandy Bridge family of processors available from the Intel Corporation).

Processing circuitry 204 may be configured to execute various instructions in device 200. Instructions may include program code configured to cause processing circuitry 204 to perform activities related to reading data, writing data, processing data, formulating data, converting data, transforming data, etc. Information (e.g., instructions, data, etc.) may be stored in memory circuitry 206. Memory circuitry 206 may comprise random access memory (RAM) and/or read-only memory (ROM) in a fixed or removable format. RAM may include volatile memory configured to hold information during the operation of device 200 such as, for example, static RAM (SRAM) or Dynamic RAM (DRAM). ROM may include non-volatile (NV) memory circuitry configured based on BIOS, UEFI, etc. to provide instructions when device 200 is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power circuitry 208 may include internal power sources (e.g., a battery, fuel cell, etc.) and/or external power sources (e.g., electromechanical or solar generator, power grid, external fuel cell, etc.), and related circuitry configured to supply device 200 with the power needed to operate. User interface circuitry 210 may include hardware and/or software to allow users to interact with device 200 such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware in user interface circuitry 210 may be incorporated within device 200 and/or may be coupled to device 200 via a wired or wireless communication medium. In an example implementation wherein device 200 is a multiple device system, user interface circuitry 210 may be optional in devices such as, for example, servers (e.g., rack/blade servers, etc.) that omit user interface circuitry 210 and instead rely on another device (e.g., an operator terminal) for user interface functionality.

Communications interface circuitry 212 may be configured to manage packet routing and other functionality for communication circuitry 214, which may include resources configured to support wired and/or wireless communications. In some instances, device 200 may comprise more than one set of communication circuitry 214 (e.g., including separate physical interface circuitry for wired protocols and/or wireless radios) managed by communications interface circuitry 212. Wired communications may include serial and parallel wired or optical mediums such as, for example, Ethernet, USB, Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth, WLAN, Wi-Fi, ZigBee, etc.), long range wireless mediums (e.g., cellular wide-area radio communication technology, satellite-based communications, etc.), electronic communications via sound waves, lasers, etc. In one embodiment, communications interface circuitry 212 may be configured to prevent wireless communications that are active in communication circuitry 214 from interfering with each other. In performing this function, communications interface circuitry 212 may schedule activities for communication circuitry 214 based on, for example, the relative priority of messages awaiting transmission. While the embodiment disclosed in FIG. 2 illustrates communications interface circuitry 212 being separate from communication circuitry 214, it may also be possible for the functionality of communications interface circuitry 212 and communication circuitry 214 to be incorporated into the same circuitry.

Consistent with the present disclosure, at least data sourcing circuitry 104′, data analysis circuitry 106′ and/or audio generation circuitry 108′ may, alone or in combination, interact with system circuitry 202 and/or communication circuitry 214. For example, data sourcing circuitry 104′ may interact with memory circuitry 206 to obtain locally-sourced multimedia data 112′, with user interface circuitry 210 to obtain captured multimedia data 114′, with communication circuitry to obtain network-sourced multimedia data 116′ from external source 216, etc. Data analysis circuitry 106′ may interact with processing circuitry 204 and/or memory circuitry 206 when, for example, determining at least one audio source in video and/or at least one attributable sound in audio. Audio generation circuitry 108′ may interact with at least user interface circuitry 210 and/or memory circuitry 206. In at least one embodiment, user interface circuitry 210 may correspond to presentation circuitry 110 in FIG. 1, and may present video along with immersive audio on device 200. Moreover, audio generation circuitry 108′ may also store immersive audio in memory circuitry 206.

In at least one embodiment, at least part of the presentation of the video and immersive audio may take place on peripheral device 218. Examples of peripheral device 218 may include a video and/or audio presentation device such as a wearable video playback device, audio device (e.g., headphones) or a combination of the two. Peripheral device 218 may comprise at least user interface circuitry 210′ and communication circuitry 214′. User interface circuitry 210′ may be implemented in a manner similar to user interface circuitry 210 in device 200. Communication circuitry 214′ may support wired and/or wireless interaction similar to communication circuitry 214 in device 200. In an example of operation, at least audio generation circuitry 108′ in device 200 may employ communication circuitry 214 in device 200 to transmit a signal comprising the immersive audio, and possibly the video, to user interface circuitry 210′ in peripheral device 218 via communication circuitry 214′ in device 200. For example, device 200 may be a smart phone, tablet computer, etc. capable of presenting at least the video portion of multimedia data, while peripheral device 218 may be headphones coupled to device 200 via a wired/wireless connection, peripheral device 218 being able to present an immersive audio portion of the multimedia data.

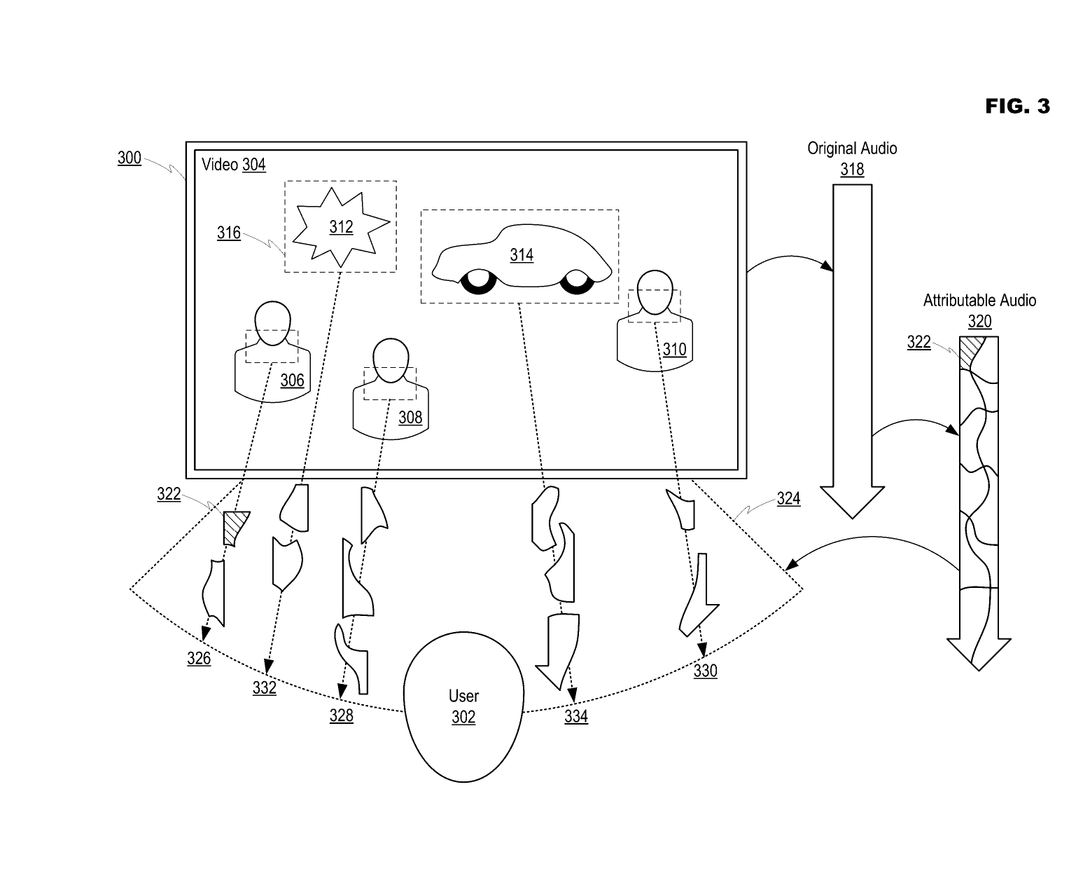

FIG. 3 illustrates an example wherein non-spatial audio is converted to immersive audio in accordance with at least one embodiment of the present disclosure. In the example shown in FIG. 3, a video presentation device 300 (e.g., monitor, television, projector, etc.) is presenting a video portion of multimedia content (e.g., video 304) to user 302. Video 304 may comprise, for example, human beings 306, 308 and 310, events 312, moving objects 314 (e.g., an automobile), etc. Consistent with the present disclosure, sources of audio in video 304 may be determined as shown by various dotted frames 316. A variety of technologies may be employed to make this determination. For example, Intel RealSense® technology, and more specifically the software developer's kit (SDK), may comprise various libraries for object detection, face detection, scene perception, motion detection, depth sensing, etc. At least the motions sensing functionality of the SDK libraries may be employed to, for example, identify faces of people 306, 308 and 310, animals, etc. within video 304, detect the motion of a person's or animal's mouth or lips moving on a previously detected face, detect the motion of an object 314 moving within video 304, detect explosive detritus moving within video 304, etc. All of the above examples may be considered to be potential sources of audio within video 304.

Moreover, if video 304 was captured employing a properly-enabled capture equipment, infrared capture data may be utilized in determining the relative and/or absolute depth of objects, relative and/or absolute temperature of objects, etc. This information, alone or in combination with the motion capture information, may be used to determine sources of audio. For example, depth sensing may be used to detect a size, shape, etc. of an object, and based this information, at least a category for the detected object may be determined (e.g., a person, an automobile, etc.). For example, when depth sensing is available (e.g., when the camera is able to sense depth data) as part of the video capture an audio source may initially be located in a three-dimensional (3D) coordinate system relative to a capture device (e.g., camera). When depth data is unavailable, the audio source may be located in a two-dimensional (2D) coordinate system relative to the camera. The audio source may then be translated from the 2D or 3D coordinate system of the camera into each user's 3D coordinate system using, for example, the initial camera position, subjective monocular cues, the user's head location/orientation information, etc. Moreover, areas within video 304 sensed to be at approximately human body temperature (e.g., 98.6° F.) may be deemed a person within video 304, and thus, a potential source of audio. Other examples may include warmer temperatures sensed corresponding to, for example, a running automobile, a fire, an explosion, a collision, etc. While some examples are provided, other methodologies for determining sources of audio may also be employed consistent with the present disclosure.

As further illustrated in FIG. 3, original audio 318 (e.g., non-spatial audio) may then be analyzed to determine at least one attributable sound. Original audio 318 may be analyzed using audio signal processing techniques to determine attributable audio 320. Attributable audio 320 may comprise sound 322 that may be attributed to different sources of audio in video 304. When immersive audio 324 is then generated, attributable sounds 322 may be spatially associated with various sources of sound in video 304 (e.g., may be encoded in immersive audio 324 so as to appear to emanate from the corresponding source of audio within video 304). For example, certain sounds 322 may be attributed to person 306 as shown at 326, to person 308 as shown at 328, to person 310 as shown at 330, to event 312 (e.g., an explosion) as shown at 332, to object 314 (e.g. an automobile) as shown at 334, etc. When user 302 watches video 304 and listens to immersive audio 324, it may appear to user 302 that the audio streams 326 to 334 emanate from sources 306 to 314, respectively. In this manner, user 302 may be more “immersed” within the multimedia experience. Movies and television programs may appear more real, teleconferences may appear to more like actual face-to-face meetings, and thus, user 302 may be more engaged.

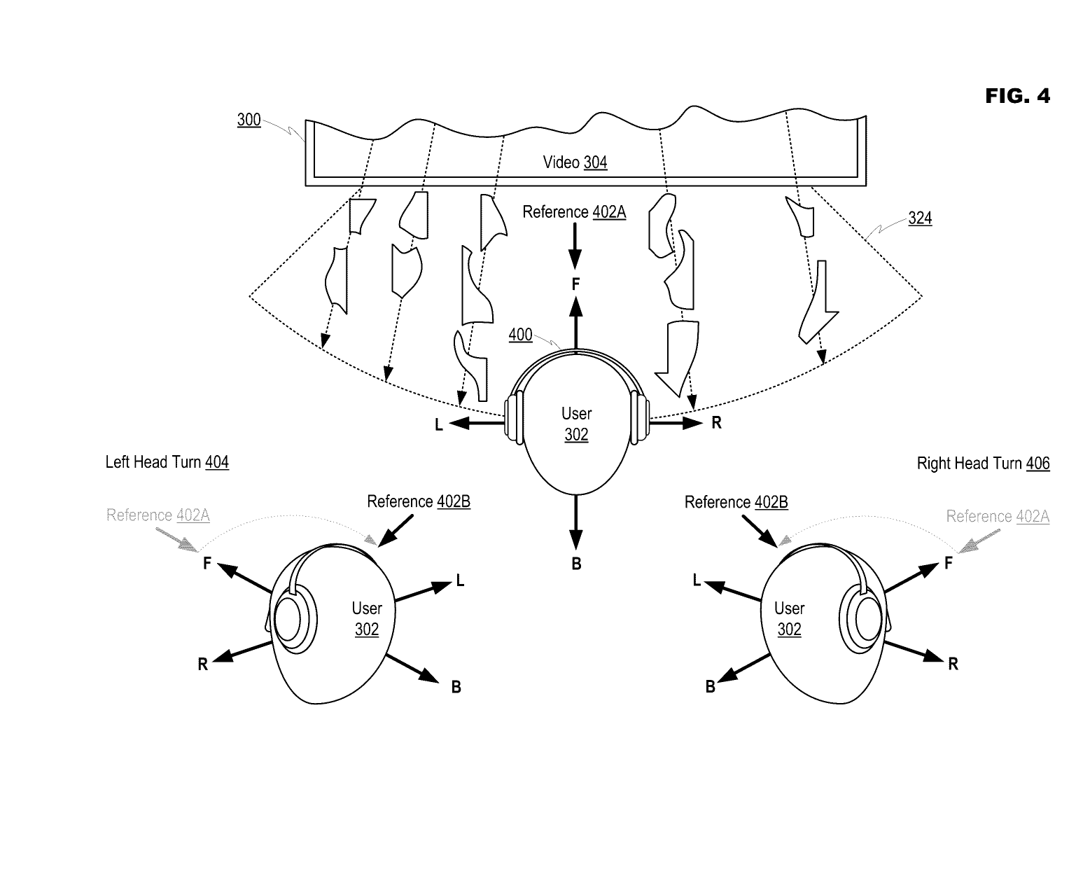

FIG. 4 illustrates an example wherein user head position is considered when generating immersive audio in accordance with at least one embodiment of the present disclosure. In general, immersive sound may be presented via speakers (e.g., four or more speakers arranged in a surround sound configuration that includes at least front, left, right and back), via headphones capable of producing spatial sound, etc. When immersive sound is presented to each user (e.g., viewer of presentation) via headphones, the sound presentation may be adjusted for each user based on a particular user's head orientation and/or position.

FIG. 4 builds upon the example originally disclosed in FIG. 3. Additional functionality is illustrated in FIG. 4, wherein the position and/or orientation of the head of user 302 may be considered when generating immersive audio 324. The position or orientation of the head of user 302 may be determined based on, for example, image or video capture by capture equipment within, or at least coupled to, presentation device 300. For example, a camera in a smart phone, tablet computer, laptop, peripheral device, etc. coupled to a television or monitor, etc. may be able to track the face of user 302, and thus, to determine the head position, orientation, etc. of user 302. Alternatively, user 302 may wear headphones 400, and the position of headphones 400 may be tracked using relative positioning (e.g., direction-of-receipt estimation for local signals, orientation sensing, movement sensing such as velocity and/or acceleration sensing, etc.) or absolute positioning (e.g., Global Positioning System (GPS) sensing, etc.).

A local coordinate system may be assigned to user 302 to define directions with respect to user 302 such as front (F), left (L), right (R) and back (B). This coordinate space may define how immersive sound 324 is to be generated. For example, at least one reference point 402A may be established. Reference 402A may correspond to the front (F) of user 302. In system wherein presentation device 300 is stationary along with the equipment that presents immersive audio 324 the coordinate space remains fixed. This is the case because no matter how user 302 moves, video 304 and sound 324 are fixed in the same coordinate space. However, a problem may occur when video presentation device 300 and a peripheral device 218 (e.g., headphones 400) that presents immersive audio 324 can be in different coordinate spaces. Headphones 400 remain oriented with the head of user 302. Thus, when user 302 looks to the left or right the coordinate system moves as well. This disrupts the alignment of audio streams 326 to 334 with audio sources 306 to 314, respectively, breaking the immersion of user 302 in the presentation.

In at least one embodiment, the head position and/or orientation of user 302 may be tracked, and generation of immersive audio 324 may be adjusted accordingly. As shown at 404, a left head turn may cause reference 402B to replace reference 402A so that immersive sound may remain pinned to presentation device 300 and video 304. For example, at least audio generation circuitry 108 may alter the generation of immersive sound 324 to be referenced to reference 402B on the right side of the head of user 302. Likewise, as shown at 406, a right head turn by user 302 would cause reference 402C to replace reference 402A so that immersive audio 324 remains synchronized, from a directional standpoint, with video 304. This is seen wherein reference 402C is now located on the left side of the head of user 302. Thus, regardless of how user 302 moves, immersive audio 324 may always originate from where video 304 is presented.

In at least one embodiment, some or all of the immersive audio generation may occur in at least one peripheral device 218. Audio generation may occur in a sound reproduction device (e.g., headphones 400) or in a device to which the sound reproduction device is coupled such as, but not limited to, a surround sound decoder standing alone or incorporated within an audio (e.g., stereo) amplifier, a home theatre receiver, a television, etc. For example, some or all of audio generation circuitry 108′ may be relocated from device 200 into at least one peripheral device 218 to support the generation of the immersive audio. This configuration may be advantageous in that the immersive audio generation may require the user's head position and/or orientation in certain situations, such as in the example shown in FIG. 4, so it may be easier to perform the calculations related to audio generation in the device where the final presentation occurs (e.g., in a sound reproduction device or a device to which the sound reproduction device is coupled).

But what you are saying is also possible, i.e. to have the immersive sound calculation done before assuming user head orientation/location of (0,0,0) and adjusting the immersive sounds at the presentation stage accounting for real user head orientation/location.

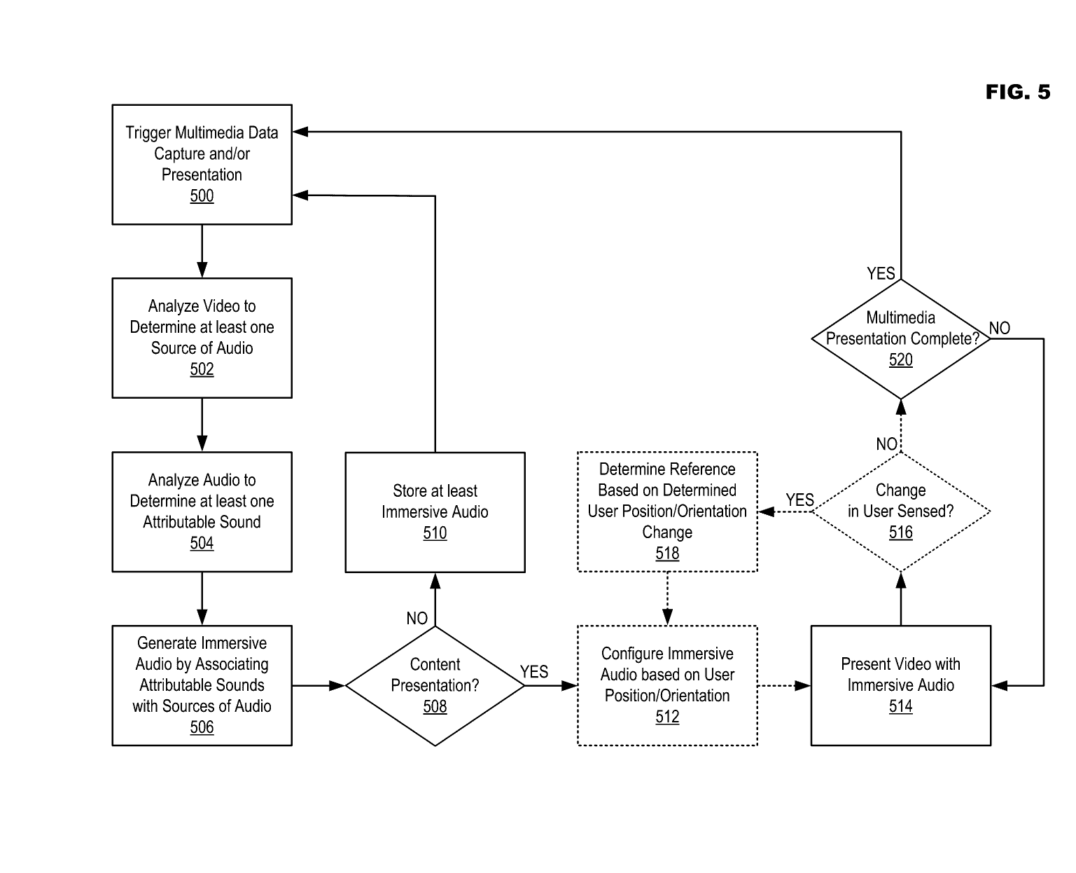

FIG. 5 illustrates example operations for generating immersive audio utilizing visual cues in accordance with at least one embodiment of the present disclosure. Operations illustrated with dotted lines may be optional. These operations may be implemented embodiments wherein, for example, user head tracking is employed to adjust the generation of immersive audio. Initially, in operation 500 multimedia data capture and/or presentation may be triggered. Triggering may occur due to, for example, user interaction with a device, an application on the device, automatic device operations, etc. Video in the multimedia data may be analyzed to determine at least one source of audio in operation 502. The video analysis may utilize various detection technologies to identify people, objects, events, etc. Similarly, non-spatial sound from the multimedia data may be analyzed in operation 504 to determine at least one attributable sound. Immersive audio may then be generated by spatially associating the at least one attributable sound with the at least one audio source in operation 506.

Following the generation of immersive audio in operation 506, a determination may be made in operation 508 as to whether content presentation has been triggered. If in operation 508 it is determined that content presentation has not been triggered (e.g., that only content capture will occur), then in operation 510 the immersive audio may be stored (e.g., in memory circuitry in the device). Operation 510 may be followed by a return to operation 500 to wait for the next triggering of multimedia capture and/or presentation. A determination in operation 508 that content presentation has been triggered may be followed by configuring the immersive audio based on user position and/or orientation in operation 512. Presentation of the video and immersive audio may then proceed in operation 514. In at least one embodiment, user head position and/or orientation may be monitored during the presentation of the video and immersive audio in operation 514. A determination may then be made in operation 516 as to whether a change has been sensed in the user (e.g., whether the user's head position and/or orientation has changed). If in operation 516 it is determined that the user has changed, then in operation 518 a new reference may be determined based on the determined user change (e.g., the amount that the user's head position and/or orientation has changed). Operation 518 may be followed by a return to operation 512 to reconfigure the immersive audio. If in operation 516 it is determined that the user has not changed (e.g., that the user's head position and orientation has not changed), then a further determination may be made in operation 520 as to whether the multimedia presentation is complete. If in operation 520 it is determined that the presentation is not complete, then the presentation may continue in operations 514 to 518. A determination in operation 520 that the presentation is complete may be followed by a return to operation 500 to wait for the next triggering of multimedia capture and/or presentation.

While FIG. 5 illustrates operations according to an embodiment, it is to be understood that not all of the operations depicted in FIG. 5 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more mediums (e.g., non-transitory storage mediums) having stored therein, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, the present disclosure is directed to a system for generating immersive audio utilizing visual cues. In general, a system may be capable of transforming non-spatial audio (e.g., simple mono or stereo sound) associated with video into immersive sound (e.g., wherein sound may be generated spatially so that it appears to emanate directly from sound sources in the video). An example device may comprise data sourcing circuitry to receive multimedia data including at least video and non-spatial audio corresponding to the video, data analysis circuitry to determine at least one source of audio in the video and at least one attributable sound in the audio and audio generation circuitry to generate immersive audio wherein the at least one attributable sound is at least spatially associated with the at least one source of audio. Audio sources in the video may be determined using a variety of different types of detection.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for generating immersive audio utilizing visual cues.

According to example 1 there is provided at least one device for generating immersive audio. The at least one device may comprise data analysis circuitry to analyze multimedia data including video and non-spatial audio, wherein analyzing the multimedia data includes determining at least one source of audio within the video and at least one attributable sound within the non-spatial audio and audio generation circuitry to generate immersive audio wherein the at least one attributable sound is at least spatially associated with the at least one source of audio.

Example 2 may include the elements of example 1, further comprising data sourcing circuitry to receive multimedia data including at least video and non-spatial audio corresponding to the video.

Example 3 may include the elements of any of examples 1 to 2, further comprising presentation circuitry to present at least one of the video or the immersive audio.

Example 4 may include the elements of any of examples 1 to 3, further comprising at least one of memory circuitry to store at least one of the video or the immersive audio, capture equipment to capture the video or communication circuitry to interact with a wired or wireless network to receive the video from at least one external source.

Example 5 may include the elements of example 4, wherein the at least one external source includes at least one data server device accessible via the Internet.

Example 6 may include the elements of any of examples 4 to 5, wherein the communication circuitry is to transmit at least one of the video, the non-spatial audio or the immersive audio to a peripheral device for at least one of processing or presentation.

Example 7 may include the elements of example 6, wherein at least a portion of the audio generation circuitry is located in the peripheral device.

Example 8 may include the elements of any of examples 6 to 7, wherein the peripheral device is at least one of headphones, a surround sound processor, an audio amplifier or a home theater system.

Example 9 may include the elements of any of examples 1 to 8, wherein the audio generation circuitry is to alter a spatial orientation with which the at least one attributable sound is associated in the immersive audio based on a position or orientation of a user's head determined by the at least one device.

Example 10 may include the elements of example 9, wherein the audio generation circuitry is to translate a location of the at least one source of audio from a video-based coordinate system to a coordinate system based on the position or orientation of the user's heard.

Example 11 may include the elements of example 10, wherein there are a plurality of user's and the audio generation circuitry is to translate the location into coordinate systems corresponding to each of the plurality of users.

Example 12 may include the elements of any of examples 1 to 11, wherein in determining at least one source of audio within the video the data analysis circuitry is to identify certain motion in the video.

Example 13 may include the elements of example 12, wherein in identifying certain motion the data analysis circuitry is to detect at least one face in the video and detect speech-related motion occurring within the at least one face.

Example 14 may include the elements of any of examples 12 to 13, wherein in identifying certain motion the data analysis circuitry is to detect motion of an object occurring in the video.

Example 15 may include the elements of any of examples 12 to 14, wherein in identifying certain motion the data analysis circuitry is to at least one of detect at least one face in the video and detect speech-related motion occurring within the at least one face or detect motion of an object occurring in the video.

Example 16 may include the elements of any of examples 1 to 15, wherein in determining at least one source of audio within the video the data analysis circuitry is to identify sources of heat in the video.

Example 17 may include the elements of example 16, wherein sources of heat in the video determined to have a temperature near human body temperature are determined to be sources of human speech.

Example 18 may include the elements of any of examples 1 to 17, wherein in determining at least one source of audio within the video the data analysis circuitry is to identify certain objects in the video based on depth.

Example 19 may include the elements of example 18, wherein the data analysis circuitry utilizes depth sensing data to determine at least one of the size and shape of an object in the video, the object being a potential source of audio.

Example 20 may include the elements of any of examples 1 to 19, wherein in determining at least one source of audio within the video the data analysis circuitry is to at least one of identify sources of heat in the video, or identify certain objects in the video based on depth.

According to example 21 there is provided a method for generating immersive audio. The method may comprise triggering video capture or video presentation in at least one device, the video including non-spatial audio, determining, in the at least one device, at least one source of audio within the video, determining, in the at least one device, at least one attributable sound in the non-spatial audio and generating, in the at least one device, immersive audio wherein the at least one attributable sound is at least spatially associated with the at least one source of audio.

Example 22 may include the elements of example 21, and may further comprise presenting the video and the immersive audio utilizing the at least one device.

Example 23 may include the elements of any of examples 21 to 22, and may further comprise transmitting at least one of the video, the non-spatial audio or the immersive audio from the at least one device to a peripheral device and at least one of processing or presenting at least one of the video or the immersive audio utilizing the peripheral device.

Example 24 may include the elements of any of examples 21 to 23, and may further comprise determining at least one of a position or orientation of a user's head and altering a spatial orientation with which the at least one attributable sound is associated in the immersive audio based on the position or orientation of the user's head.

Example 25 may include the elements of any of examples 21 to 24, wherein determining at least one source of audio within the video comprises identifying certain motion in the video. Example 26 may include the elements of any of examples 21 to 25, wherein determining at least one source of audio within the video comprises identifying sources of heat in the video.

Example 27 may include the elements of any of examples 21 to 26, wherein determining at least one source of audio within the video comprises identifying certain objects in the video based on depth.

Example 28 may include the elements of any of examples 21 to 27, wherein determining at least one source of audio within the video comprises at least one of identifying certain motion in the video, identifying sources of heat in the video or identifying certain objects in the video based on depth.

According to example 29 there is provided a system including at least a device, the system being arranged to perform the method of any of the above examples 21 to 28.

According to example 30 there is provided a chipset arranged to perform the method of any of the above examples 21 to 28.

According to example 31 there is provided at least one machine readable medium comprising a plurality of instructions that, in response to be being executed on a computing device, cause the computing device to carry out the method according to any of the above examples 21 to 28.

According to example 32 there is provided at least one device to generate immersive audio, the at least one device being arranged to perform the method of any of the above examples 21 to 28.

According to example 33 there is provided a system for generating immersive audio. The system may comprise means for triggering video capture or video presentation in at least one device, the video including non-spatial audio, means for determining at least one source of audio within the video, means for determining at least one attributable sound in the non-spatial audio and means for generating immersive audio wherein the at least one attributable sound is at least spatially associated with the at least one source of audio.

Example 34 may include the elements of example 33, and may further comprise means for presenting the video and the immersive audio utilizing the at least one device.

Example 35 may include the elements of any of examples 33 to 34, and may further comprise means for transmitting at least one of the video, non-spatial audio or the immersive audio from the at least one device to a peripheral device and means for at least one of processing or presenting at least one of the video or the immersive audio utilizing the peripheral device.

Example 36 may include the elements of any of examples 33 to 35, and may further comprise means for determining at least one of a position or orientation of a user's head and means for altering a spatial orientation with which the at least one attributable sound is associated in the immersive audio based on the position or orientation of the user's head.

Example 37 may include the elements of any of examples 33 to 36, wherein the means for determining at least one source of audio within the video comprise means for identifying certain motion in the video.

Example 38 may include the elements of any of examples 33 to 37, wherein the means for determining at least one source of audio within the video comprise means for identifying sources of heat in the video.

Example 39 may include the elements of any of examples 33 to 38, wherein the means for determining at least one source of audio within the video comprise means for identifying certain objects in the video based on depth.

Example 40 may include the elements of any of examples 33 to 39, wherein determining at least one source of audio within the video comprises at least one of means for identifying certain motion in the video, means for identifying sources of heat in the video or means for identifying certain objects in the video based on depth.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. At least one device for generating immersive audio, comprising:
data analysis circuitry to analyze multimedia data including video and non-spatial audio, wherein analyzing the multimedia data includes determining at least one source of audio within the video and at least one attributable sound within the non-spatial audio; and
audio generation circuitry to generate immersive audio wherein the at least one attributable sound is at least spatially associated with the at least one source of audio.

2. The at least one device of claim 1, further comprising data sourcing circuitry to receive multimedia data including at least video and non-spatial audio corresponding to the video.

3. The at least one device of claim 1, further comprising presentation circuitry to present at least one of the video or the immersive audio.

4. The at least one device of claim 1, further comprising at least one of:
memory circuitry to store at least one of the video or the immersive audio;
capture equipment to capture the video; or
communication circuitry to interact with a wired or wireless network to receive the video from at least one external source.

5. The at least one device of claim 4, wherein the communication circuitry is to transmit at least one of the video, the non-spatial audio or the immersive audio to a peripheral device for at least one of processing or presentation.

6. The at least one device of claim 1, wherein the audio generation circuitry is to alter a spatial orientation with which the at least one attributable sound is associated in the immersive audio based on a position or orientation of a user's head determined by the at least one device.

7. The at least one device of claim 1, wherein in determining at least one source of audio within the video the data analysis circuitry is to identify certain motion in the video.

8. The at least one device of claim 7, wherein in identifying certain motion the data analysis circuitry is to detect at least one face in the video and detect speech-related motion occurring within the at least one face.

9. The at least one device of claim 7, wherein in identifying certain motion the data analysis circuitry is to detect motion of an object occurring in the video.

10. The at least one device of claim 1, wherein in determining at least one source of audio within the video the data analysis circuitry is to identify sources of heat in the video.

11. The at least one device of claim 1, wherein in determining at least one source of audio within the video the data analysis circuitry is to identify certain objects in the video based on depth.

12. A method for generating immersive audio, comprising:
triggering video capture or video presentation in at least one device, the video including non-spatial audio;
determining, in the at least one device, at least one source of audio within the video;
determining, in the at least one device, at least one attributable sound in the non-spatial audio; and
generating, in the at least one device, immersive audio wherein the at least one attributable sound is at least spatially associated with the at least one source of audio.

13. The method of claim 12, further comprising:
presenting the video and the immersive audio utilizing the at least one device.

14. The method of claim 12, further comprising:
transmitting at least one of the video, the non-spatial audio or the immersive audio from the at least one device to a peripheral device; and
at least one of processing or presenting at least one of the video or the immersive audio utilizing the peripheral device.

15. The method of claim 12, further comprising:
determining at least one of a position or orientation of a user's head; and
altering a spatial orientation with which the at least one attributable sound is associated in the immersive audio based on the position or orientation of the user's head.

16. The method of claim 12, wherein determining at least one source of audio within the video comprises identifying certain motion in the video.

17. The method of claim 12, wherein determining at least one source of audio within the video comprises identifying sources of heat in the video.

18. The method of claim 12, wherein determining at least one source of audio within the video comprises identifying certain objects in the video based on depth.

19. At least one machine-readable storage medium having stored thereon, individually or in combination, instructions for generating immersive audio that, when executed by one or more processors, cause the one or more processors to:
trigger video capture or video presentation in at least one device, the video including non-spatial audio;
determine at least one source of audio within the video;
determine at least one attributable sound in the non-spatial audio; and
generate immersive audio wherein the at least one attributable sound is at least spatially associated with the at least one source of audio.

20. The storage medium of claim 19, further comprising instructions that, when executed by one or more processors, cause the one or more processors to:
present the video and the immersive audio utilizing the at least one device.

21. The storage medium of claim 19, further comprising instructions that, when executed by one or more processors, cause the one or more processors to:
transmit at least one of the video, non-spatial audio or the immersive audio from the at least one device to a peripheral device; and
at least one of process or present at least one of the video or the immersive audio utilizing the peripheral device.

22. The storage medium of claim 21, further comprising instructions that, when executed by one or more processors, cause the one or more processors to:
determine at least one of a position or orientation of a user's head; and
alter a spatial orientation with which the at least one attributable sound is associated in the immersive audio based on the position or orientation of the user's head.

23. The storage medium of claim 19, wherein the instructions to determine at least one source of audio within the video comprise instructions to identify certain motion in the video.

24. The storage medium of claim 19, wherein the instructions to determine at least one source of audio within the video comprise instructions to identify sources of heat in the video.

25. The storage medium of claim 19, wherein the instructions to determine at least one source of audio within the video comprise instructions to identify certain objects in the video based on depth.
